(19) United States
(12) Patent Application Publication
(10) Pub. No.: US 2016/0379661 A1
(43) Pub. Date: Dec. 29, 2016

(54) NOISE REDUCTION FOR ELECTRONIC DEVICES

(71) Applicant: Intel IP Corporation, Santa Clara, CA (US)

(72) Inventors: Swarnendu Kar, Hillsboro, OR (US); Navin Chatlani, Maraval (TT)

(73) Assignee: Intel IP Corporation, Santa Clara, CA (US)

(21) Appl. No.: 14/751,613

(22) Filed: Jun. 26, 2015

(51) Int. Cl. G10L 21/0232; G10L 21/02; G10L 25/84

(52) U.S. Cl. CPC G10L 21/0232; G10L 25/84; G10L 21/0205; G10L 2021/02165

(57) ABSTRACT

In one example a controller comprises logic, at least partially including hardware logic, configured to detect speech activity in an audio signal received in a non-aerial microphone and in response to the voice activity, to apply a noise cancellation algorithm to a speech input received in a aerial microphone. Other examples may be described.

### BACKGROUND

The subject matter described herein relates generally to the field of electronic devices and more particularly to noise reduction for electronic devices.

Many electronic devices such as laptop computers, netbook style computers, tablet computers, mobile phones, electronic readers, and the like have communication capabilities, e.g., voice and text messaging, built into the devices. In some circumstances it may be useful to communicate with such electronic devices using an interface on ancillary electronic devices such as headsets, computer-equipped glasses, or the like.

Accordingly, in some circumstances systems and techniques to provide noise reduction when communication via electronic devices may find utility.

### BRIEF DESCRIPTION OF THE DRAWINGS

The detailed description is described with reference to the accompanying figures.

FIG. 1 is an illustration of exemplary electronic devices which may be adapted to work with noise reduction in accordance with some examples.

FIG. 2 is a schematic illustration of components of a wearable device which may be adapted to implement noise reduction for electronic devices in accordance with some examples.

FIG. 3 is a high-level schematic illustration of a controller which may be adapted to implement noise reduction for electronic devices in accordance with some examples.

FIG. 4 is a high-level schematic illustration of an environment in which noise reduction for electronic devices may be implemented in accordance with some examples.

FIG. 5 is a flowchart illustrating operations in a method to implement noise reduction for electronic devices in accordance with some examples.

FIGS. 6-10 are schematic illustrations of electronic devices which may be adapted to implement noise reduction in accordance with some examples.

### DETAILED DESCRIPTION

Described herein are exemplary systems and methods to implement noise reduction for electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

By way of background, noise reduction may be used in conjunction with electronic devices which support audio input, including phones, tablets and computers. Noise reduction may also be used in wearable devices such as glasses or earpieces. Wearable devices provide the ability to capture audio signals from both aerial microphones and in non-aerial microphones, e.g., bone conduction microphones and in-ear microphones, where the audio is transmitted through bone and ear-canal respectively. These modalities are sometimes referred to as non-aerial microphones, distinguishing them from ordinary microphones which use air as the medium of transmission.

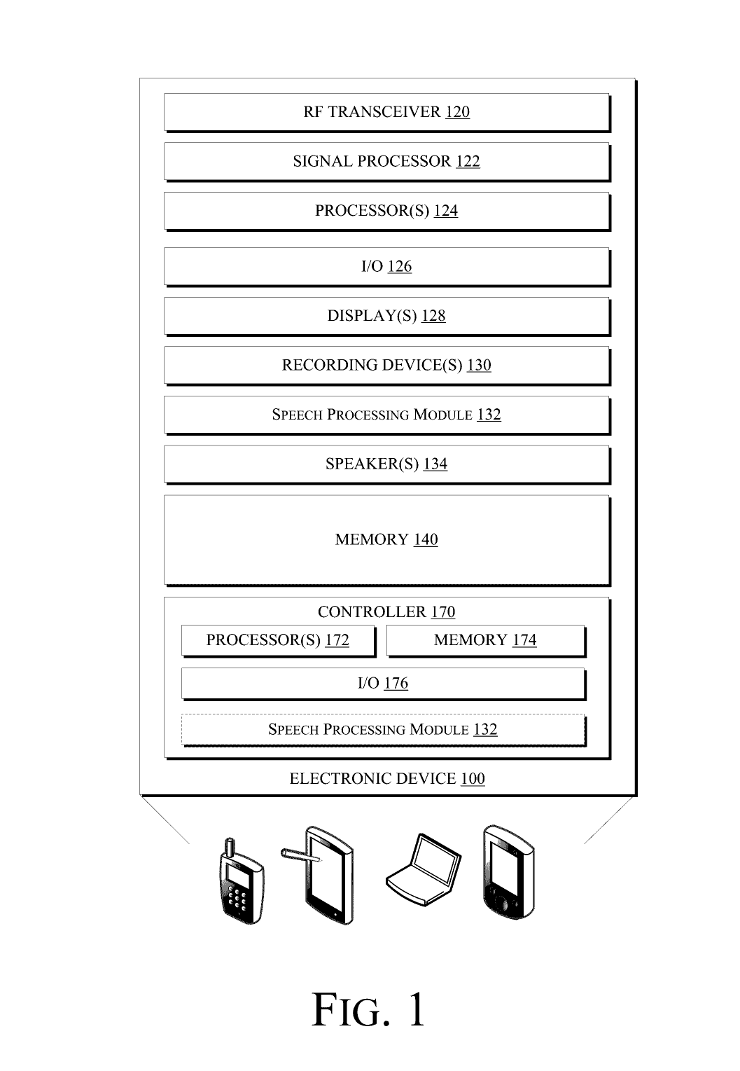

Many modern noise reduction techniques make an initial classification of speech frames into frames which include voice or speech input and frames which do not include voice or speech frames. Described herein are noise reduction techniques for enhancing noisy speech captured by electronic devices which receive inputs from both aerial and non-aerial microphones. The noise reduction techniques described herein extract information from both aerial and non-aerial microphones to make voice/non-voice classifications to improve the performance of noise reduction systems. Further details will be described with reference to FIGS. 1-10.

FIG. 1 is a schematic illustration of an example of an electronic device 100. In some aspects remote electronic device 100 may be embodied as a mobile telephone, a tablet computing device, a personal digital assistant (PDA), a notepad computer, a video camera or the like. The specific embodiment of remote electronic device 100 is not critical.

In some examples electronic device 100 may include an RF transceiver 120 to transceive RF signals and a signal processing module 122 to process signals received by RF transceiver 120. RF transceiver 120 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Remote electronic device 100 may further include one or more processors 124 and memory 140. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some examples, processor 124 may be one or more processors in the family of processors available from Intel® Corporation of Santa Clara, Calif. Alternatively, other processors may be used, such as Intel's Itanium®, XEON™, ATOM™, and Celeron® processors. Also, one or more processors from other manufactures may be utilized. Moreover, the processors may have a single or multi core design.

In some examples, memory 140 includes random access memory (RAM); however, memory module 140 may be implemented using other memory types such as dynamic RAM (DRAM), synchronous DRAM (SDRAM), and the like. Memory 140 may comprise one or more applications which execute on the processor(s) 124.

Remote electronic device 100 may further include one or more input/output devices 126 such as, e.g., a keypad, touchpad, microphone, or the like, and one or more displays 128, speakers 134, and one or more recording devices 130. By way of example, recording device(s) 130 may comprise one or more cameras and/or microphones A speech processing module 132 may be provided to process speech input receive by I/O device(s) 126 such as one or more microphones.

In some examples remote electronic device 100 may include a low-power controller 170 which may be separate from processor(s) 124, described above. In the example depicted in FIG. 1 the controller 170 comprises one or more processor(s) 172, a memory module 174, and an I/O module 176. In some examples the memory module 174 may comprise a persistent flash memory module and the I/O module 176 may be implemented as logic instructions encoded in the persistent memory module, e.g., firmware or software. The I/O module 176 may comprise a serial I/O module or a parallel I/O module. Again, because the adjunct controller 170 is physically separate from the main processor(s) 124, the controller 170 can operate independently while the processor(s) 124 remains in a low-power consumption state, e.g., a sleep state. Further, the low-power controller 170 may be secure in the sense that the low-power controller 170 is inaccessible to hacking through the operating system. In some examples a low-power instance of the speech processing module 132 may execute on controller 170.

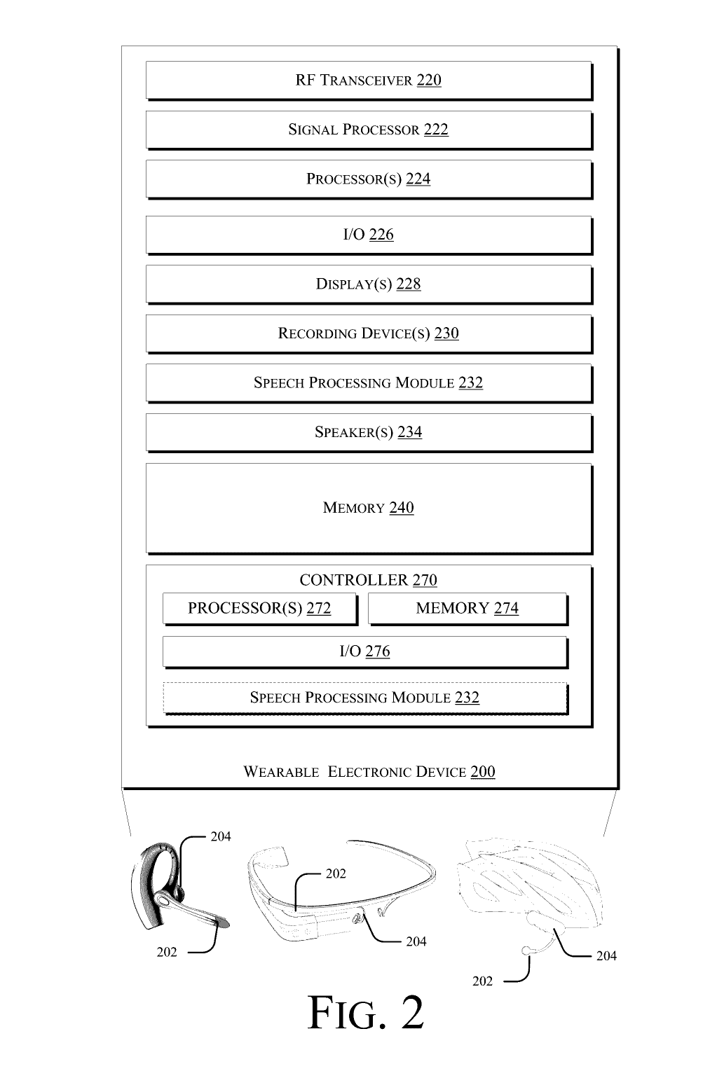

FIG. 2 is a schematic illustration of components of a wearable device 200 which may be adapted to implement noise reduction for electronic devices in accordance with some examples. Many of the components of wearable electronic device 200 may be the same as the corresponding components for the electronic device 100 depicted in FIG. 1. In the interest of brevity and clarity, the description of these components will not be repeated.

As illustrated in FIG. 2, in some examples the wearable electronic device 200 may be implemented as a wearable electronic device such as an earpiece or a headset. Electronic device 200 may comprise at least aerial microphones 202 or non-aerial microphones 204, e.g., ear microphones or bone-conduction microphones.

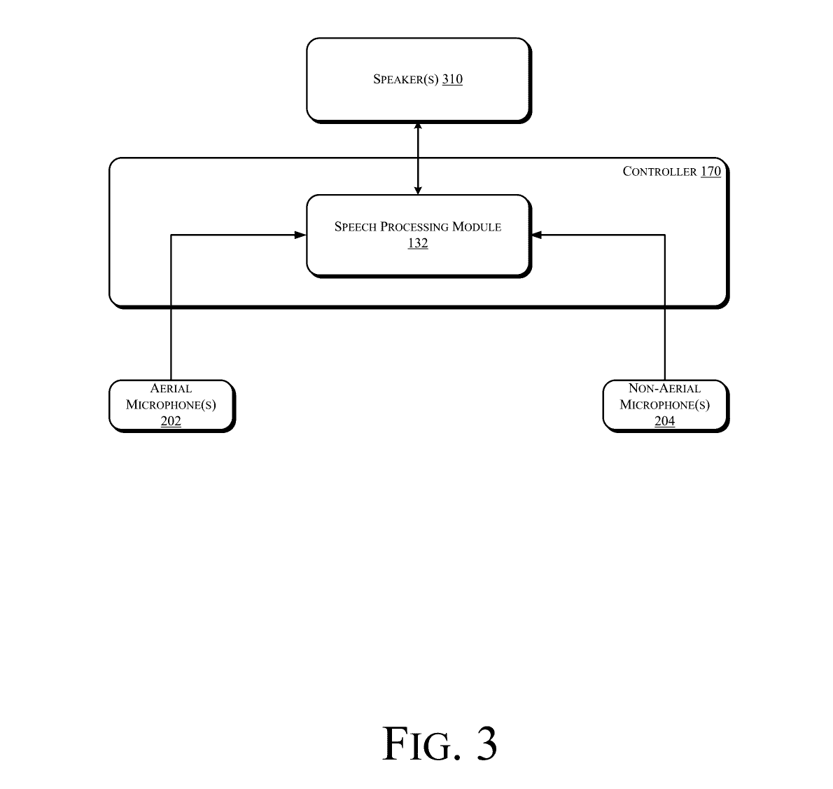

FIG. 3 is a high-level schematic illustration of a controller which may be adapted to implement noise reduction for electronic devices in accordance with some examples. Referring to FIG. 3, in some environments a wearable electronic device 200 include at least one aerial microphone 202 and at least one non-aerial microphone 204 to receive audio input, as described above. The aerial microphone 202 and the non-aerial microphone 204 may be coupled to speech processing module 132 such that audio inputs to the aerial microphone 202 and the non-aerial microphone 204 are directed to the speech processing module 132 which, in turn, may be coupled to one or more speakers 310.

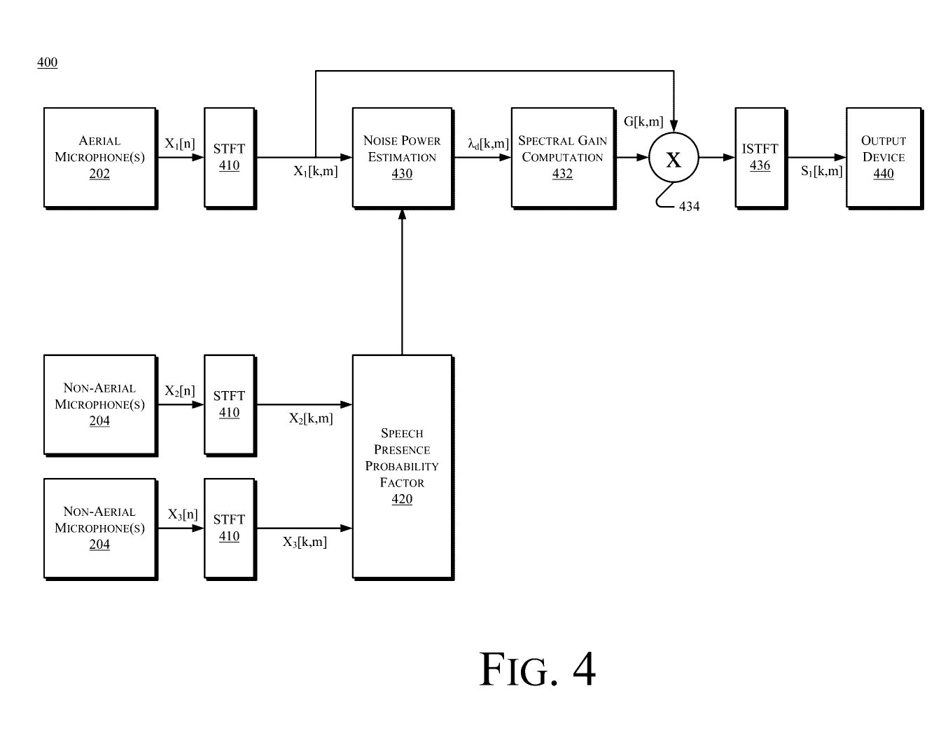

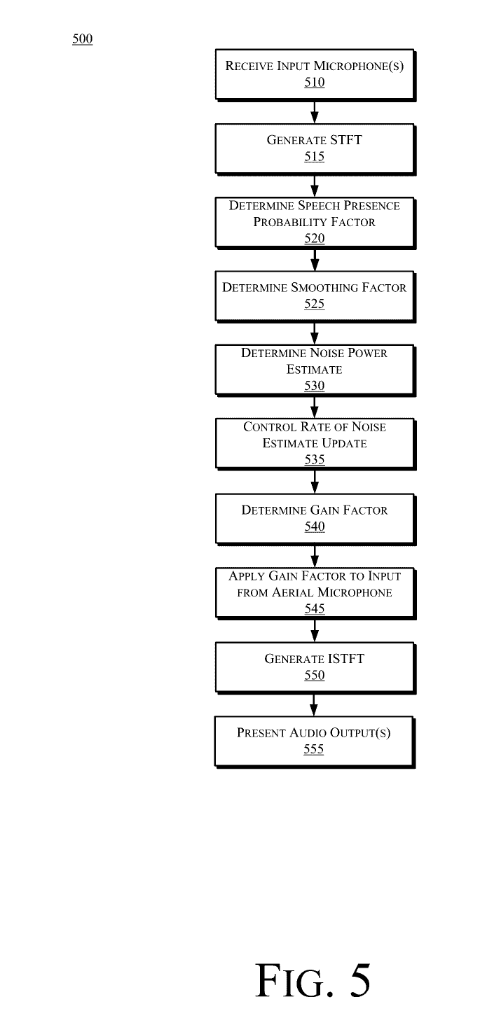

Having described various structures to implement noise reduction in electronic devices, further operating aspects will be explained with reference to FIGS. 4-5. FIG. 4 is a high-level schematic illustration of an environment 400 in which noise reduction for electronic devices may be implemented in accordance with some examples, and FIG. 5 is a flowchart illustrating operations in a method to implement noise reduction for electronic devices in accordance with some examples.

Referring to FIGS. 4 and 5, in some examples a noise reduction system may implement a model described by:

xᵢ[n]=sᵢ[n]+dᵢ[n] EQ 1:

where xᵢ[n] represents a noisy speech signal recorded by the i^{th} microphone in the system, sᵢ[n] represents the noise-free speech at the i^{th} microphone, and di[n] represents the noise source at the i^{th} microphone, which is assumed to be independent of the speech.

The Short Time Fourier Transform (STFT) of EQ1 may be written as:

Xⱼ(k,m)=Sᵢ(k,m)+Dᵢ(k,m) EQ2:

for frequency bin k and time frame n.

Thus, referring to FIGS. 4-5, at operation 510 input is received from aerial microphone(s) 202 and from non-aerial microphones 204. At operation 515 the STFT 410 of the audio inputs from the aerial microphone(s) 202 and from non-aerial microphones 204 is determined.

At operation 520 a speech probability is determined. Non-aerial microphones 204 provide a better indication of the presence of speech than the aerial microphones 202. Thus, at operation 520 inputs from non-aerial microphones 204 may be analyzed to determine a speech presence probability factor 420 for a specific frame thereby indicating the presence of speech. In some examples a speech presence probability factor (block 420) may be expressed as p(k,m) varies between 0 and 1, where p(k,m)=1 indicates the presence of clean speech only and p(k,m)=0 indicates the absence of speech. Values of p(k,m) in the range between 0 and 1 indicate the presence of noisy speech.

At operation 525 the speech presence probability factor 420 may be used to determine a the time-varying, frequency dependent smoothing factor α̅_{d}(k,m) given by the equation:

α̅_{d}(k,m)=α_{d}+(1−α_{d})p(k,m) EQ3:

where the smoothing parameter α_{d} ranges between 0 and 1.

At operation 530 a noise power estimation module 430 may generate a noise power estimate \hat{λ}_{d}(k,m) from the input to the aerial microphone(s) 202 by recursive averaging as follows:

\hat{λ}_{d}(k,m+1)=α̅_{d}(k,m)\hat{λ}_{d}(k,m)+[1−α̅_{d}(k,m)]|X₁(k,m)|² EQ4:

At operation 535 the time smoothing factor α̅_{d}(k,m) is used to control a rate of updating the noise power estimate. At operation 540 a noise estimate \hat{λ}_{d}(k,m) may be used by a spectral gain computation block 432 to compute a gain factor G(k,m) using spectral subtraction given by:

$$G ( k , m ) = \sqrt{1 - \frac{{\tilde{λ}}_{d} ( k , m )}{{\vert {X}_{1} ( k , m ) \vert}^{2}}} \qquad EQ5$$

The speech presence probability factor p(k,m) is used in the gain computation factor determination to control a balance between speech preservation and noise reduction.

At operation 545 the gain factor G(k,m) determined in operation 540 is applied to the input from the aerial microphone 202. In some examples the input X₁(k,m) from the aerial microphone 202 may be multiplied by the gain factor G(k,m) in a multiplier module 434 to obtain a noise-reduced signal Ŝ₁(k,m).

At operation 550 the inverse STFT (ISTFT) of the noise reduced signal Ŝ₁(k,m) is determined at block 436, and at operation 555 the noise-reduced speech signal is presented as audio output on an output device 440, e.g. a speaker or the like.

Thus, the structures and operations described herein enable an electronic device, alone or in cooperation with a wearable device, to generate a noise-reduced speech signal based on inputs from both aerial microphones 202 and non-aerial microphones 204. In some examples inputs from the non-aerial microphones 204 are used to determine a speech presence probability factor 420 which is, in turn, used in the generation of spectral gain factors.

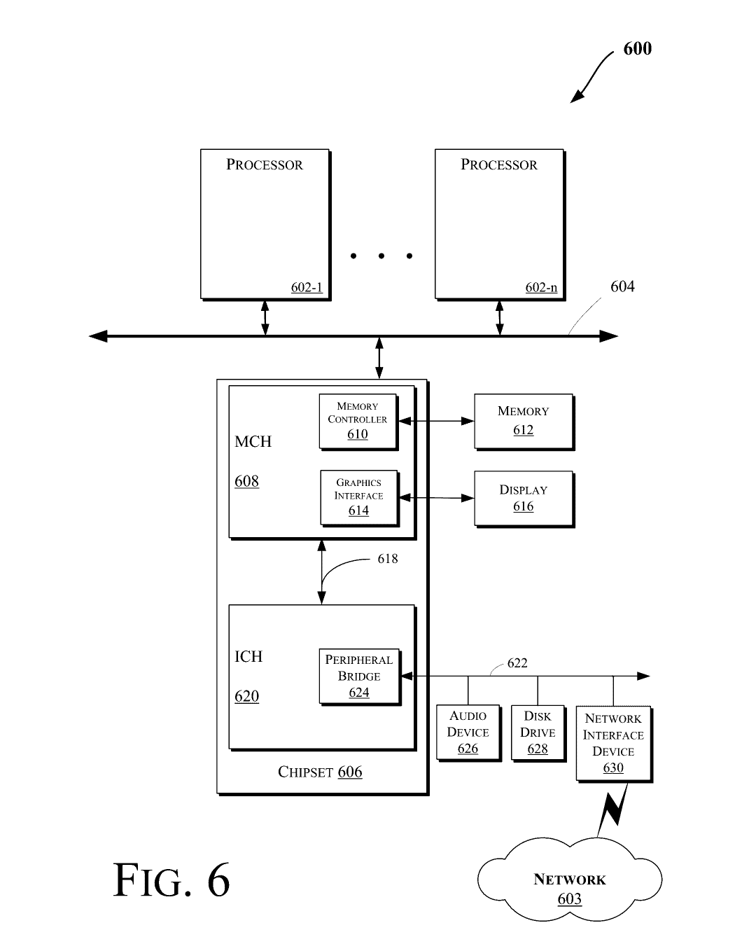

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 124 discussed with reference to FIG. 1 or processor 224 of FIG. 2. Also, the operations discussed with reference to FIGS. 4-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612. The memory 612 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

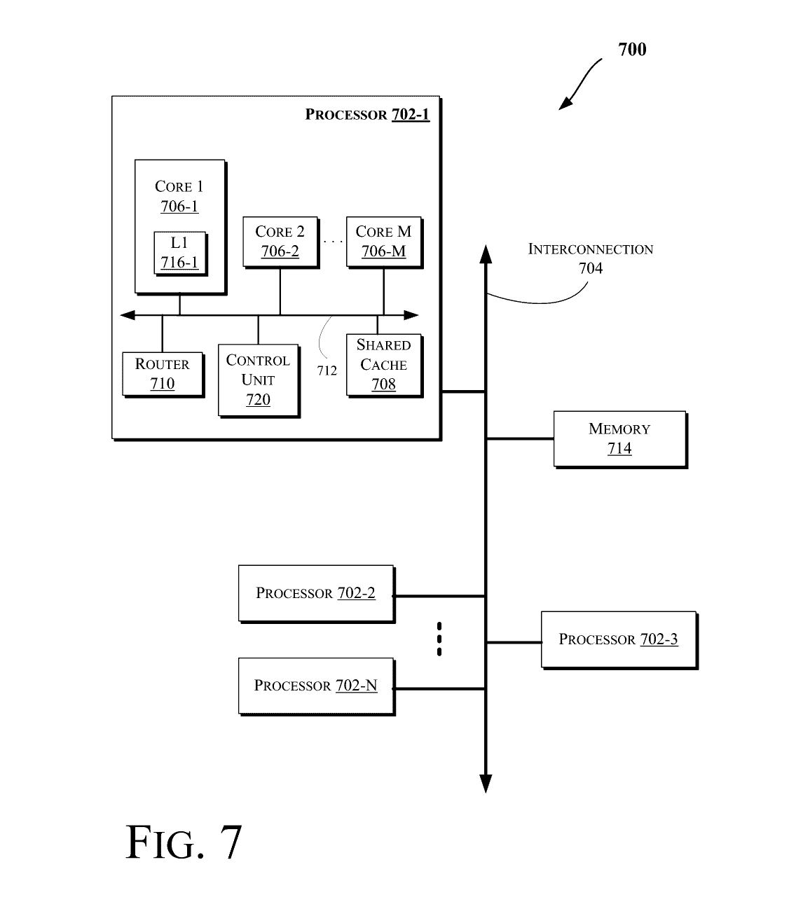

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

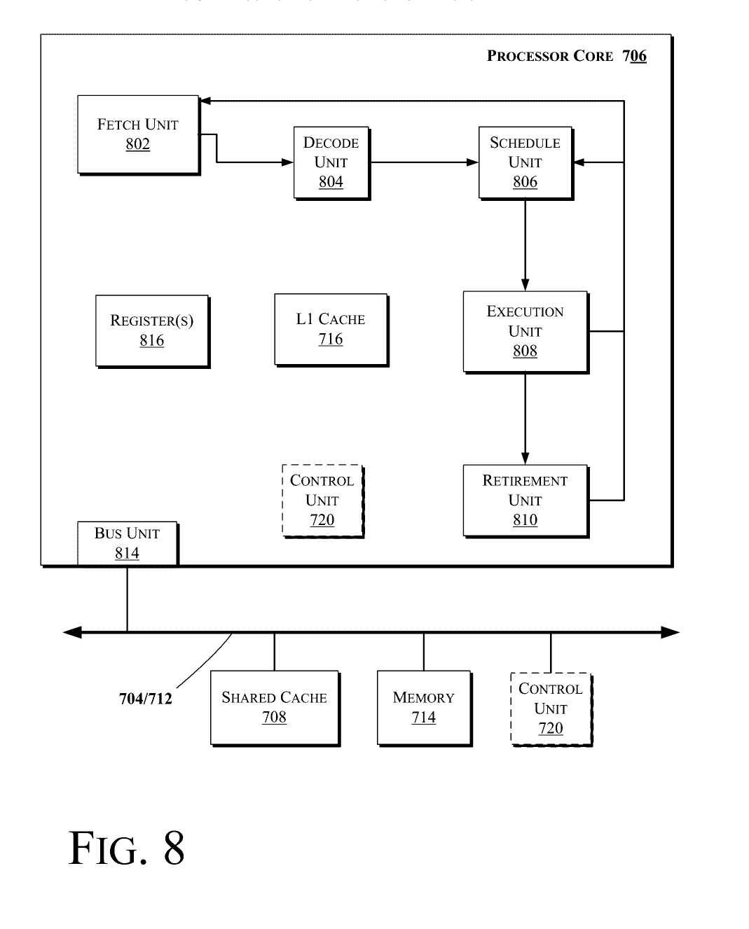

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

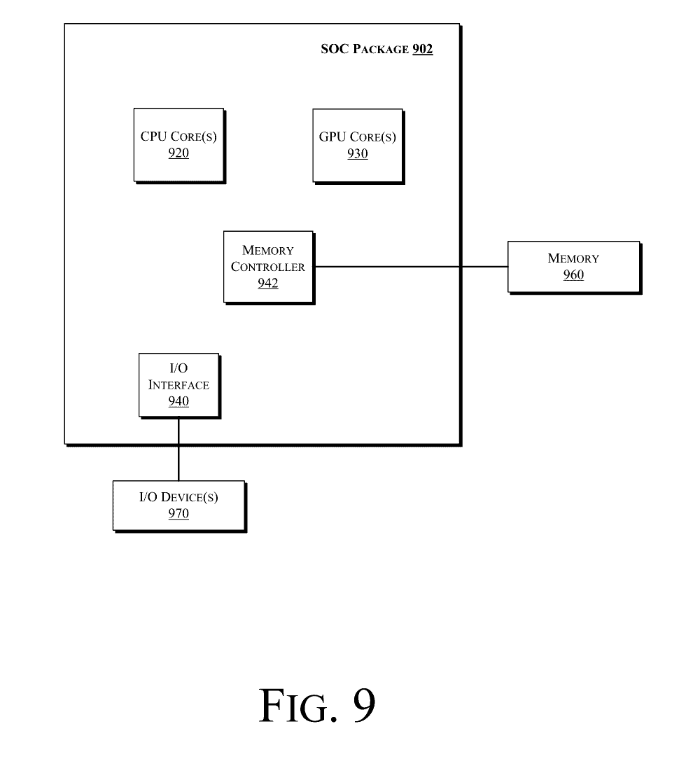

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

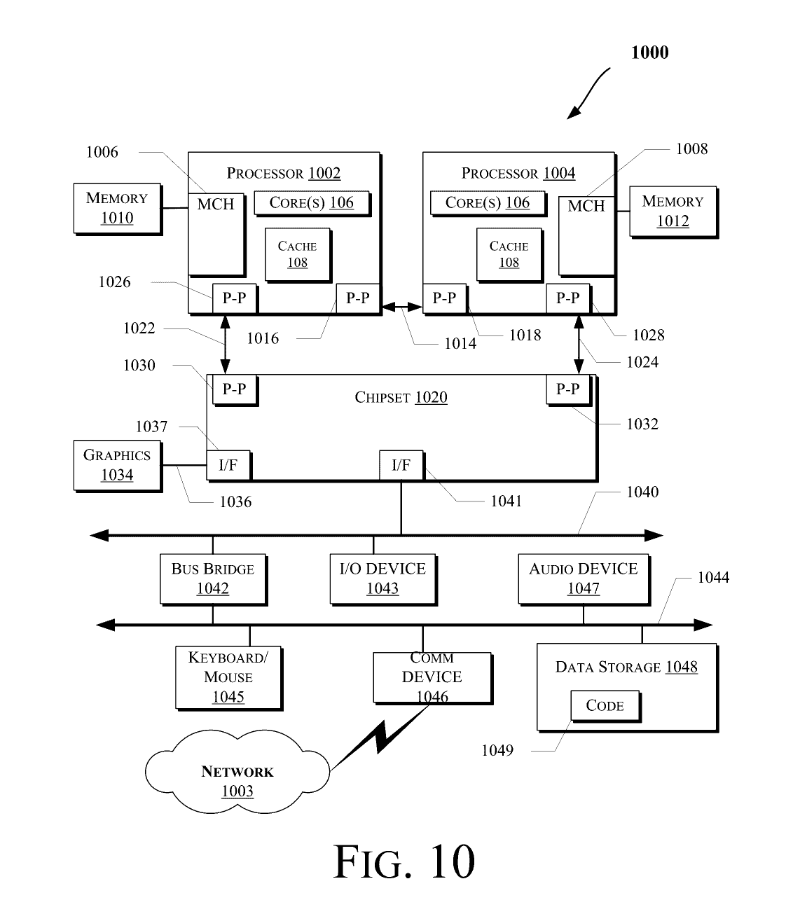

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertain to further examples.

Example 1 is a controller comprising logic, at least partially including hardware logic, configured to detect speech activity in an audio signal received in a non-aerial microphone and in response to the voice activity, to apply a noise cancellation algorithm to a speech input received in a aerial microphone

In Example 2, the subject matter of Example 1 can optionally include an arrangement in which the controller comprises logic to determine a speech presence probability factor from the audio signal received in the non-aerial microphone.

In Example 3, the subject matter of any one of Examples 1-2 can optionally include logic further configured to determine a time-varying, frequency dependent smoothing factor using the speech presence probability factor.

In Example 4, the subject matter of any one of Examples 1-3 can optionally include logic further configured to control a rate of updating a noise estimate to the speech input received in the aerial microphone using the time-varying, frequency dependent smoothing factor.

In Example 5, the subject matter of any one of Examples 1-4 can optionally include logic further configured to determine a gain factor based at least in part on the speech presence probability factor.

In Example 6, the subject matter of any one of Examples 1-5 can optionally include logic further configured to apply the gain factor to the speech input received in a aerial microphone.

In Example 7, the subject matter of any one of Examples 1-6 can optionally include logic further configured to present an audio output on an output device.

Example 8 is an electronic device, comprising an input/output (I/O) interface to receive a first audio signal from a non-aerial microphone and a second audio signal from an aerial microphone and a controller, comprising logic, at least partially including hardware logic, configured to detect speech activity in an audio signal received in a non-aerial microphone and in response to the voice activity, to apply a noise cancellation algorithm to a speech input received in a aerial microphone.

In Example 9, the subject matter of Example 8 can optionally include an arrangement in which the controller comprises logic to determine a speech presence probability factor from the audio signal received in the non-aerial microphone.

In Example 10, the subject matter of any one of Examples 8-9 can optionally include logic further configured to determine a time-varying, frequency dependent smoothing factor using the speech presence probability factor.

In Example 11, the subject matter of any one of Examples 9-10 can optionally include logic further configured to control a rate of updating a noise estimate to the speech input received in the aerial microphone using the time-varying, frequency dependent smoothing factor.

In Example 12, the subject matter of any one of Examples 9-11 can optionally include logic further configured to determine a gain factor based at least in part on the speech presence probability factor.

In Example 13, the subject matter of any one of Examples 9-12 can optionally include logic further configured to apply the gain factor to the speech input received in a aerial microphone.

In Example 14, the subject matter of any one of Examples 9-13 can optionally include logic further configured to present an audio output on an output device

Example 15 is a computer program product comprising logic instructions stored on a tangible computer readable medium which, when executed by a controller, configure the controller to detect speech activity in an audio signal received in a non-aerial microphone and in response to the voice activity, to apply a noise cancellation algorithm to a speech input received in a aerial microphone.

In Example 16 the subject matter of Example 15 can optionally include logic instructions stored on a tangible computer readable medium which, when executed by the controller, configure the controller to determine a speech presence probability factor from the audio signal received in the non-aerial microphone.

In Example 17 the subject matter of any one of Examples 15-16 can optionally include logic instructions stored on a tangible computer readable medium which, when executed by the controller, configure the controller to determine a time-varying, frequency dependent smoothing factor using the speech presence probability factor.

In Example 18 the subject matter of any one of Examples 15-17 can optionally include logic instructions stored on a tangible computer readable medium which, when executed by the controller, configure the controller to control a rate of updating a noise estimate to the speech input received in the aerial microphone using the time-varying, frequency dependent smoothing factor.

In Example 19 the subject matter of any one of Examples 15-18 can optionally include logic instructions stored on a tangible computer readable medium which, when executed by the controller, configure the controller to determine a gain factor based at least in part on the speech presence probability factor.

In Example 20 the subject matter of any one of Examples 15-19 can optionally include logic instructions stored on a tangible computer readable medium which, when executed by the controller, configure the controller to apply the gain factor to the speech input received in a aerial microphone.

In Example 21 the subject matter of any one of Examples 15-20 can optionally include logic instructions stored on a tangible computer readable medium which, when executed by the controller, configure the controller to present an audio output on an output device.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A controller, comprising:
logic, at least partially including hardware logic, configured to:
detect speech activity in an audio signal received in a non-aerial microphone; and
in response to the voice activity, to apply a noise cancellation algorithm to a speech input received in a aerial microphone.

2. The controller of claim 1, wherein the controller comprises logic to determine a speech presence probability factor from the audio signal received in the non-aerial microphone.

3. The controller of claim 2, wherein the controller comprises logic to determine a time-varying, frequency dependent smoothing factor using the speech presence probability factor.

4. The controller of claim 3, wherein the controller comprises logic to control a rate of updating a noise estimate to the speech input received in the aerial microphone using the time-varying, frequency dependent smoothing factor.

5. The controller of claim 4, wherein the controller comprises logic to determine a gain factor based at least in part on the speech presence probability factor.

6. The controller of claim 5, wherein the controller comprises logic to apply the gain factor to the speech input received in a aerial microphone.

7. The controller of claim 6, wherein the controller comprises logic to present an audio output on an output device.

8. An electronic device, comprising:
an input/output (I/O) interface to receive a first audio signal from a non-aerial microphone and a second audio signal from an aerial microphone; and
a controller, comprising logic, at least partially including hardware logic, configured to:
detect speech activity in an audio signal received in a non-aerial microphone; and
in response to the voice activity, to apply a noise cancellation algorithm to a speech input received in a aerial microphone.

9. The electronic device of claim 8, wherein the controller comprises logic to determine a speech presence probability factor from the audio signal received in the non-aerial microphone.

10. The electronic device of claim 9, wherein the controller comprises logic to determine a time-varying, frequency dependent smoothing factor using the speech presence probability factor.

11. The electronic device of claim 10, wherein the controller comprises logic to control a rate of updating a noise estimate to the speech input received in the aerial microphone using the time-varying, frequency dependent smoothing factor.

12. The electronic device of claim 11, wherein the controller comprises logic to determine a gain factor based at least in part on the speech presence probability factor.

13. The electronic device of claim 12, wherein the controller comprises logic to apply the gain factor to the speech input received in a aerial microphone.

14. The electronic device of claim 13, wherein the controller comprises logic to present an audio output on an output device.

15. A computer program product comprising logic instructions stored on a tangible computer readable medium which, when executed by a controller, configure the controller to:
detect speech activity in an audio signal received in a non-aerial microphone; and
in response to the voice activity, to apply a noise cancellation algorithm to a speech input received in a aerial microphone.

16. The computer program product of claim 15, comprising logic instructions stored on a tangible computer readable medium which, when executed by the controller, configure the controller to determine a speech presence probability factor from the audio signal received in the non-aerial microphone.

17. The computer program product of claim 16, comprising logic instructions stored on a tangible computer readable medium which, when executed by the controller, configure the controller to determine a time-varying, frequency dependent smoothing factor using the speech presence probability factor.

18. The computer program product of claim 17, comprising logic instructions stored on a tangible computer readable medium which, when executed by the controller, configure the controller to control a rate of updating a noise estimate to the speech input received in the aerial microphone using the time-varying, frequency dependent smoothing factor.

19. The computer program product of claim 18, comprising logic instructions stored on a tangible computer readable medium which, when executed by the controller, configure the controller to determine a gain factor based at least in part on the speech presence probability factor.

20. The computer program product of claim 19, comprising logic instructions stored on a tangible computer readable medium which, when executed by the controller, configure the controller to apply the gain factor to the speech input received in a aerial microphone.

21. The computer program product of claim 20, comprising logic instructions stored on a tangible computer readable medium which, when executed by the controller, configure the controller to present an audio output on an output device.
